(19) United States
(12) Patent Application Publication
(10) Pub. No.: US 2010/0096969 A1
(43) Pub. Date: Apr. 22, 2010

(54) FIELD EMISSION DEVICE AND BACKLIGHT UNIT INCLUDING THE SAME

(75) Inventors: Ha-jin Kim, Suwon-si (KR); Yong-chul KIM, Seoul (KR); In-taek Han, Seoul (KR); Ho-suk Kang, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/436,245

(22) Filed: May 6, 2009

(30) Foreign Application Priority Data
Oct. 21, 2008 (KR) 10-2008-0103204
Jan. 20, 2009 (KR) 10-2009-0004573

(51) Int. Cl. H01J 1/02

(52) U.S. Cl. 313/309; 977/762

(57) ABSTRACT

Afield emission device includes; a substrate, a plurality of cathode electrodes disposed on the substrate, and a plurality of fiber emitters respectively disposed on the plurality of cathode electrodes and each of the plurality of fiber emitters including; at least one conductive fiber and a plurality of carbon nanotubes disposed on surfaces of the at least one conductive fiber.

### CROSS-REFERENCE TO RELATED APPLICATIONS

This application claims priority to Korean Patent Application No. 10-2008-0103204, filed on Oct. 21, 2008, and Korean Patent Application No. 10-2009-0004573, filed on Jan. 20, 2009, and all the benefits accruing therefrom under 35 U.S.C. §119, the contents of which in its entirety are herein incorporated by reference.

### BACKGROUND

1. Field

One or more embodiments relate to a field emission device including a fiber emitter and a backlight unit including the field emission device.

2. Description of the Related Art

Field emission devices are devices that emit electrons from an emitter formed on a cathode electrode due to a strong electric field formed around the emitter. Such field emission devices may typically be applied to various systems using electron emission, such as a backlight unit used in a liquid crystal display (“LCD”) device, a field emission display device, an X-ray tube, a microwave amplifier, and a flat lamp.

LCD devices are devices that display an image on a front surface by transmitting light, which is provided from a backlight unit disposed on a rear surface, through a liquid crystal layer that adjusts transmittance of light therethrough. A typical backlight unit may include a cold cathode fluorescent lamp (“CCFL”) backlight unit, a light emitting diode (“LED”) backlight unit, and a field emission type backlight unit. The CCFL backlight unit has disadvantages in that it is difficult to increase the size of a screen due to the need for longer and/or more numerous CCFLs and it is difficult or not practical to perform a local dimming method that can compensate for a slow response speed of a liquid crystal molecule and can improve image quality. As used herein, local dimming refers to a technique of dividing a light emitting surface of a backlight unit into a plurality of regions and independently controlling selected regions to emit different, e.g., additional, amounts of light. Such local dimming can improve the energy efficiency of the backlight unit and can significantly improve the image quality of an LCD device.

The LED backlight unit can achieve local dimming but the use of LEDs may be expensive.

The field emission type backlight unit typically emits light by permitting electrons emitted from a field emission device to collide with a fluorescent layer formed on an anode electrode. Such a field emission type backlight unit has advantages in that it is easy to increase the size of a screen, local dimming can be achieved, and the field emission type backlight unit is more cost effective than the LED backlight unit. Accordingly, research into field emission type backlight units has become increasingly important.

Carbon nanotube (“CNT”) emitters, which have good electron emission characteristics and high mechanical and chemical stability, have recently been used as electron emission sources in field emission devices. Typically, there are two methods of forming a CNT emitter on a substrate. The first method is to form a paste, which is a mixture of an organic binder and CNT powder, on a desired position of a substrate using screen printing. The second method is to directly grow CNTs on a substrate using chemical vapor deposition (“CVD”).

The first method using the paste has advantages in that a continuous process using screen printing is possible and mass production is also possible, but has a disadvantage in that an activation process is required after a CNT emitter is formed. That is, after the CNT emitter is formed using screen printing, CNTs remain at least partially obscured by the paste, thereby deteriorating field emission characteristics. Accordingly, an activation process of exposing the CNTs to the outside of the paste and aligning the exposed CNTs in an electric field direction is typically performed. The activation process refers to a process of exposing the CNTs through the paste to the outside and aligning the CNTs using an adhesive tape or an adhesive elastomer.

However, the first method using the paste has disadvantages in that the activation process using the adhesive tape or the adhesive elastomer may damage the CNTs, and electron emission uniformity and the reliability and lifespan of the CNT emitter may be degraded since organic materials may remain inside the CNT emitter.

The second method using the CVD forms a catalyst on a position where CNTs are to be grown and grows the CNTs in a high temperature CVD device. The second method using the CVD has disadvantages in that the material and size of a substrate are limited due to the use of high temperature conditions and the size of a CVD chamber, and a manufacturing time is increased since a continuous process is difficult or not practical.

### SUMMARY

One or more exemplary embodiments include a field emission device including a fiber emitter and a backlight unit including the field emission device.

An exemplary embodiment of a field emission device includes; a substrate, a plurality of cathode electrodes disposed on the substrate, and a plurality of fiber emitters respectively disposed on the plurality of cathode electrodes and each of the plurality of fiber emitters including; at least one conductive fiber, and a plurality of carbon nanotubes (“CNTs”) disposed on surfaces of the at least one conductive fiber.

In one exemplary embodiment, each of the plurality of fiber emitters includes a plurality of braided conductive fibers.

In one exemplary embodiment, the at least one conductive fiber may include at least one of metal fibers and carbon fibers. In one exemplary embodiment, the carbon fibers may have a thermal expansion coefficient of about −1×10⁻⁶/K to about 5×10⁻⁶/K.

In one exemplary embodiment, the field emission device may further include; a first insulating layer disposed on the substrate between at least two of the plurality of cathode electrodes, and a plurality of gate electrodes disposed on the first insulating layer, wherein the plurality of gate electrodes are disposed substantially perpendicular to the plurality of cathode electrodes. In one exemplary embodiment, each of the plurality of fiber emitters includes a plurality of braided conductive fibers, and a twist pitch between the conductive fibers is one of equal to and less than a distance between the plurality of fiber emitters and the plurality of gate electrodes. In one exemplary embodiment, each of the plurality of gate electrodes includes at least one through hole located above the plurality of fiber emitters.

In one exemplary embodiment, the field emission device may further include a second insulating layer disposed between the plurality of gate electrodes and the first insulating layer. In one exemplary embodiment, the second insulating layer may at least partially cover the first insulating layer, the substrate, the plurality of cathode electrodes, and the plurality of fiber emitters which are located below the plurality of gate electrodes.

An exemplary embodiment of a field emission type backlight unit includes; a lower substrate, an upper substrate facing the lower substrate and being disposed a predetermined distance apart from the lower substrate, a plurality of cathode electrodes disposed on a top surface of the lower substrate, a plurality of fiber emitters respectively disposed on the plurality of cathode electrodes and each of the plurality of fiber emitters comprising at least one conductive fiber and a plurality of CNTs disposed on surfaces of the at least one conductive fiber, an anode electrode disposed on a bottom surface of the upper substrate, and a fluorescent layer disposed on the anode electrode.

In one exemplary embodiment, each of the plurality of fiber emitters includes a plurality of braided conductive fibers. In one exemplary embodiment, a twist pitch between the plurality of conductive fibers may be one of equal to and less than a distance between the plurality of fiber emitters and the anode electrode.

In one exemplary embodiment, the field emission type backlight unit may further include; a first insulating layer disposed on a top surface of the lower substrate between at least two of the plurality of cathode electrodes, and a plurality of gate electrodes disposed on the first insulating layer, wherein the plurality of gate electrodes are disposed substantially perpendicular to the plurality of cathode electrodes.

An exemplary embodiment of a field emission device includes; a substrate including a plurality of trenches formed therein, a plurality of cathode electrodes disposed on bottom surfaces of the plurality of trenches, respectively, and a plurality of fiber emitters respectively disposed on the plurality of cathode electrodes and each of the plurality of fiber emitters including; at least one conductive fiber, and a plurality of CNTs disposed on surfaces of the at least one conductive fiber.

In one exemplary embodiment, the field emission device may further include a plurality of gate electrodes disposed on a top surface of the substrate substantially perpendicular to the plurality of cathode electrodes.

An exemplary embodiment of a field emission type backlight unit includes; a lower substrate including a plurality of trenches formed therein, an upper substrate facing with the lower substrate and being disposed a predetermined distance apart from the lower substrate, a plurality of cathode electrodes disposed on bottom surfaces of the plurality of trenches, respectively, a plurality of fiber emitters respectively disposed on the plurality of cathode electrodes and each of the plurality of fiber emitters including; at least one conductive fiber and a plurality of CNTs disposed on surfaces of the at least one conductive fiber, an anode electrode disposed on a bottom surface of the upper substrate, and a fluorescent layer disposed on the anode electrode.

### BRIEF DESCRIPTION OF THE DRAWINGS

The above and/or other aspects, advantages, and features of exemplary embodiments of the present invention will become more apparent by describing in further detail exemplary embodiments thereof with reference, taken in conjunction with the accompanying drawings of which:

FIG. 1 is a partial perspective view of an exemplary embodiment of a field emission device and an exemplary embodiment of a field emission type backlight unit including the exemplary embodiment of a field emission device;

FIG. 2 is a partial perspective view of another exemplary embodiment of a field emission device and an exemplary embodiment of a field emission type backlight unit including the exemplary embodiment of the field emission device;

FIG. 3 is a partial perspective view of another exemplary embodiment of a field emission device and an exemplary embodiment of a field emission type backlight unit including the exemplary embodiment of a field emission device;

FIG. 4 is a partial perspective view of another exemplary embodiment of a field emission device and an exemplary embodiment of a field emission type backlight unit including the exemplary embodiment of a field emission device;

FIG. 5 is a cross-sectional view of an exemplary embodiment of a device for forming carbon nanotubes (“CNTs”) on conductive fibers using resistive heating;

FIG. 6 is a partial perspective view of another exemplary embodiment of a field emission device and an exemplary embodiment of a field emission type backlight unit including the exemplary embodiment of a field emission device;

FIG. 7 illustrates an exemplary embodiment of fiber emitters of the exemplary embodiment of a field emission device of FIG. 6;

FIG. 8 illustrates another exemplary embodiment of fiber emitters of the exemplary embodiment of a field emission device of FIG. 6;

FIG. 9 is a partial perspective view of another exemplary embodiment of a field emission device and an exemplary embodiment of a field emission type backlight unit;

FIG. 10 is a partial perspective view of another exemplary embodiment of a field emission device and an exemplary embodiment of a field emission type backlight unit; and

FIG. 11 is a partial perspective view of another exemplary embodiment of a field emission device and an exemplary embodiment of a field emission type backlight unit.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

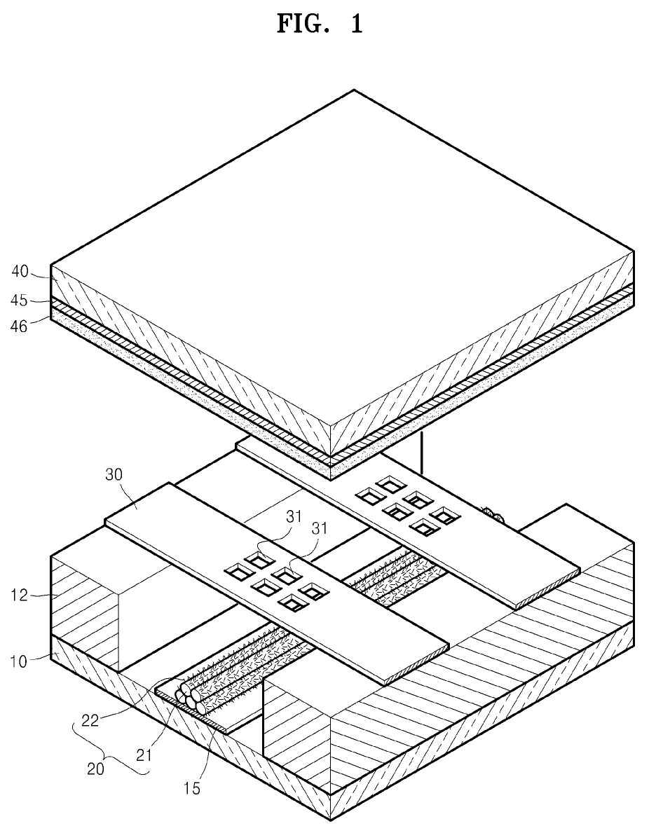

FIG. 1 is a partial perspective view of an exemplary embodiment of a field emission device and an exemplary embodiment of a field emission type backlight unit.

Referring to FIG. 1, the field emission device includes a lower substrate 10, a plurality of cathode electrodes 15 formed on the lower substrate 10, a plurality of fiber emitters 20 respectively formed on top surfaces of the plurality of cathode electrodes 15, and a plurality of gate electrodes 30 for extracting electrons from the fiber emitters 20. In one exemplary embodiment, the lower substrate 10 may include glass or other materials having similar characteristics, e.g., it may be a glass substrate, but the present embodiment is not limited thereto. Although only a single cathode electrode 15 is shown in FIG. 1, the plurality of cathode electrodes 15 are formed on the lower substrate 10 substantially in parallel to one another at predetermined intervals. In one exemplary embodiment, the cathode electrodes 15 may be formed in a stripe pattern. Exemplary embodiments of the cathode electrodes 15 may include a metal material, a transparent conductive material, exemplary embodiments of which include indium tin oxide (“ITO”), or other materials having similar characteristics.

The fiber emitters 20 are respectively disposed on the top surfaces of the cathode electrodes 15. In one exemplary embodiment, the fiber emitters 20 may extend along the length direction of the cathode electrodes 15. Each of the fiber emitters 20 includes one or more conductive fibers 21 and a plurality of carbon nanotubes (“CNTs”) 22 formed on surfaces of the conductive fibers 21. Exemplary embodiments include configurations wherein the conductive fibers 21 may include metal fibers, carbon fibers or other materials having similar characteristics. In the exemplary embodiment wherein the conductive fibers 21 include carbon fibers, metal fibers may be added in addition to the carbon fibers in order to improve conductivity of the fiber emitter 20.

In the present exemplary embodiment, carbon fiber refers to a fiber having a carbon content of over about 90%. Exemplary embodiments of which may be formed by stabilizing a precursor, such as rayon or pitch, in an oxygen atmosphere and performing carbonization and graphitization at a high temperature of equal to or higher than about 1500° C. The carbon fibers used for the conductive fibers 21 may have a low thermal expansion coefficient considering thermal deformation caused when electrons are emitted. In one exemplary embodiment, each of the carbon fibers may have a thermal expansion coefficient of about −1×10⁻⁶/K to 5×10⁻⁶/K. However, the present exemplary embodiment is not limited thereto. The CNTs 22 having good electron emission characteristics are formed on the surfaces of the conductive fibers 21. In one exemplary embodiment, the CNTs 22 may be formed on the surfaces of the conductive fibers 21 using chemical vapor deposition (“CVD”), resistive heating or other similar methods, as will be described in more detail below.

An insulating layer 12 is formed to a predetermined height on a top surface of the lower substrate 10 between adjacent cathode electrodes 15 of the plurality of cathode electrodes 15. In one exemplary embodiment, the insulating layer 12 may be formed to be substantially parallel to the cathode electrodes 15. The plurality of gate electrodes 30 for extracting electrons is formed on a top surface of the insulating layer 12. In one exemplary embodiment, the gate electrodes 30 may be formed in a stripe pattern substantially perpendicular to the plurality of cathode electrodes 15. One or more through-holes 31 may be formed in each of the gate electrodes 30, and the through-holes 31 may be located above, e.g., aligned with, the fiber emitters 20. In the field emission device constructed as described above, if a predetermined voltage is applied between the cathode electrodes 15 and the gate electrodes 30, electrons are emitted from the fiber emitters 20 and moved toward an anode electrode 45 through the through-holes 31.

An upper substrate 40 is spaced apart from the field emission device by a predetermined distance. In detail, the upper substrate 40 faces the lower substrate 10 with the predetermined distance therebetween. Exemplary embodiments of the upper substrate 40 may include glass, or other materials having similar characteristics, e.g., the upper substrate 40 may be a glass substrate, but the present exemplary embodiment is not limited thereto. The anode electrode 45 is formed on a bottom surface of the upper substrate 40. In one exemplary embodiment, the anode electrode 45 may be formed to cover the entire bottom surface of the upper substrate 40. Alternative exemplary embodiments include configurations wherein the anode electrode may be formed in a stripe pattern. Exemplary embodiments of the anode electrode 45 may be formed of a transparent conductive material. A fluorescent layer 46 is formed on a bottom surface of the anode electrode 45.

In the field emission type backlight unit constructed as described above, if predetermined voltages are respectively applied to the cathode electrodes 15, the gate electrodes 30, and the anode electrode 45, electrons are emitted from the fiber emitters 20 due to the voltages applied to the cathode electrodes 15 and the gate electrodes 30. The emitted electrons are moved toward the anode electrode 45 through the through-holes 31 formed in the gate electrodes 30, and then the emitted electrons collide with the fluorescent layer 46, causing the fluorescent layer 46 to emit light.

As described above, since the fiber emitters 20 each including the one or more conductive fibers 21 and the CNTs 22 formed on the surfaces of the one or more conductive fibers 21 are used as electron emission sources, electron emission characteristics and reliability can be improved without an activation process using an adhesive tape or an adhesive elastomer. Furthermore, since the CNTs are not damaged and there are no organic materials remaining in the fiber emitters, the lifespan of the fiber emitters can be extended.

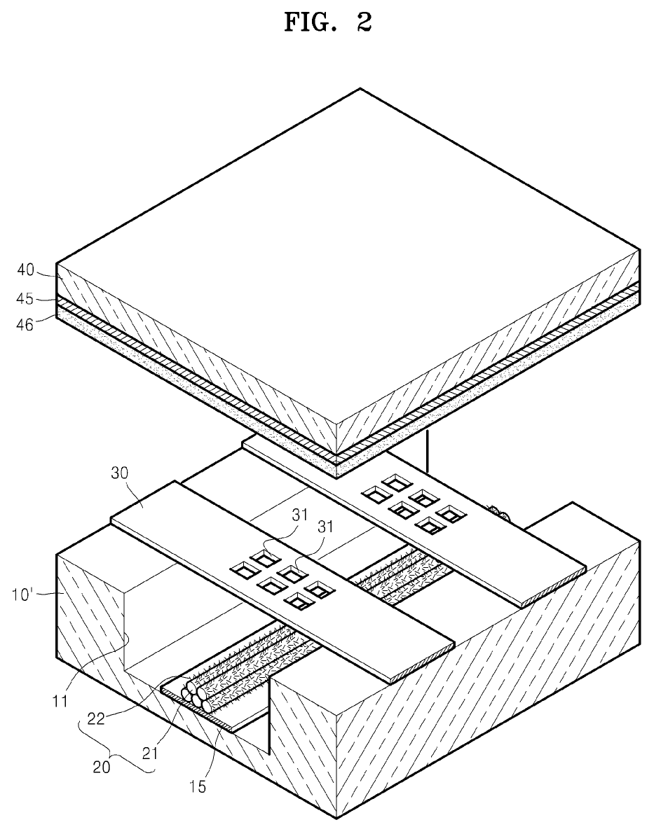

FIG. 2 is a partial perspective view of another exemplary embodiment of a field emission device and an exemplary embodiment of a field emission type backlight unit including the field emission device. The field emission device of FIG. 2 is substantially similar to the field emission device of FIG. 1 except for a difference in that the lower substrate 10 and the insulating layer 12 are integrally formed with each other. The following explanation will be made by focusing on the difference between the exemplary embodiment of a field emission device and the field emission type backlight unit of FIG. 2 and the exemplary embodiment of a field emission device and the field emission type backlight unit of FIG. 1.

Referring to FIG. 2, a plurality of trenches 11 are formed to a predetermined depth in a lower substrate 10′. In one exemplary embodiment, the trenches 11 may be formed substantially in parallel to one another with predetermined intervals therebetween. In one exemplary embodiment, the trenches 11 may be formed in a stripe pattern. The cathode electrodes 15 are respectively formed on bottom surfaces of the trenches 11, and the fiber emitters 20 are respectively formed on top surfaces of the cathode electrodes 15. The gate electrodes 30 are formed on a top surface of the lower substrate 10′ to be substantially perpendicular to the cathode electrodes 15. In one exemplary embodiment, the gate electrodes 15 may be formed in a stripe pattern.

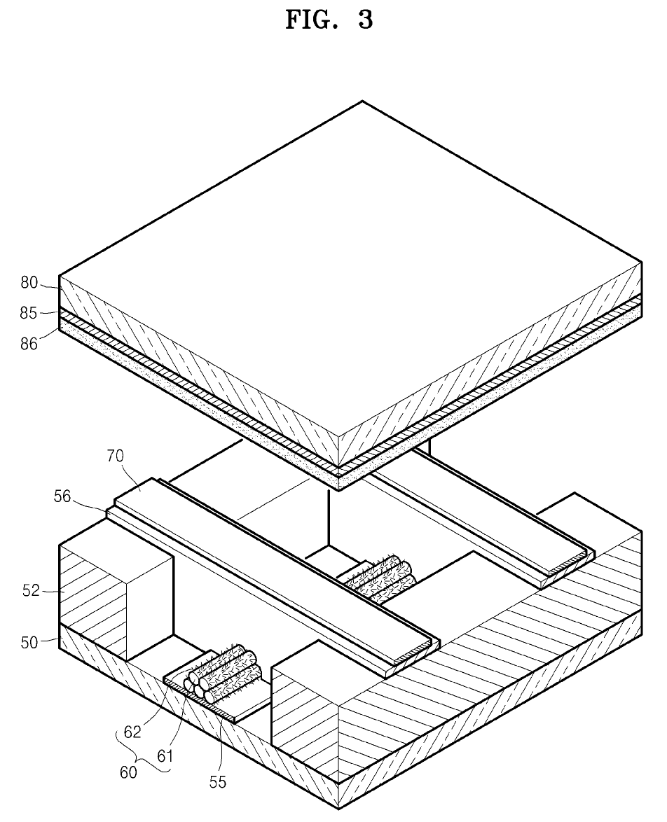

FIG. 3 is a partial perspective view of another exemplary embodiment of a field emission device and an exemplary embodiment of a field emission type backlight unit.

Referring to FIG. 3, the present exemplary embodiment of a field emission device includes a lower substrate 50, a plurality of cathode electrodes 55 formed on the lower substrate 50, a plurality of fiber emitters 60 respectively formed on top surfaces of the cathode electrodes 55, and a plurality of gate electrodes 70 for extracting electrons from the fiber emitters 60. Similar to the previous exemplary embodiments, the lower substrate 50 may include glass or other materials having similar characteristics, e.g., the lower substrate 50 may be a glass substrate, but the present embodiment is not limited thereto. The plurality of cathode electrodes 55 are formed on the lower substrate 50 substantially in parallel to one another and separated at predetermined intervals from one another. In one exemplary embodiment, the cathode electrodes 55 may be formed in a stripe pattern. Exemplary embodiments include configurations wherein the cathode electrodes 55 may be formed of a metal material, a transparent conductive material, exemplary embodiments of which include ITO, or other materials having similar characteristics.

The fiber emitters 60 are respectively disposed on the top surfaces of the cathode electrodes 55. In one exemplary embodiment, the fiber emitters 60 may extend in the length direction of the cathode electrodes 55. Each of the fiber emitters 60 includes one or more conductive fibers 61 and CNTs 62 formed on surfaces of the conductive fibers 61. Similar to the previous exemplary embodiment, the conductive fibers 61 may include metal fibers, carbon fibers, or other materials having similar characteristics. In the exemplary embodiment wherein the conductive fibers 61 include carbon fibers, metal fibers may be further included within the fiber emitter 60 in order to improve conductivity. In one exemplary embodiment, the carbon fibers used for the conductive fibers 61 may have a low thermal expansion coefficient considering thermal deformation caused when electrons are emitted. Exemplary embodiments of the carbon fibers may have a thermal expansion coefficient of about −1×10⁻⁶/K to 5×10⁻⁶/K. However, the present embodiment is not limited thereto. The CNTs 62 having good electron emission characteristics are formed on the surfaces of the conductive fibers 61. Exemplary embodiments include configurations wherein the CNTs 62 may be grown on the surfaces of the conductive fibers 61 using CVD, resistive heating or other similar techniques as described in more detail below.

A first insulating layer 52 is formed to a predetermined height on a top surface of the lower substrate 50 between the cathode electrodes 55. In one exemplary embodiment, the first insulating layer 52 may be formed substantially in parallel to the cathode electrodes 55. A second insulating layer 56 is formed on the first insulating layer 52 to correspond to the gate electrodes 70. In detail, the second insulating layer 56 may be formed between the gate electrodes 70 and the first insulating layer 52 and substantially perpendicular to the cathode electrodes 55. The second insulating layer 56 may partially cover the first insulating layer 52, the lower substrate 50, the cathode electrodes 55, and the fiber emitters 60 which are located below the gate electrodes 70. In one exemplary embodiment, the second insulating layer 56 completely envelops the underlying portions of the fiber emitter 60 and cathode electrode 55. The gate electrodes 70 for extracting electrons from the fiber emitter 60 are formed on a top surface of the second insulating layer 56 such that the gate electrodes 70 are disposed substantially perpendicular to the cathode electrodes 55. In the present exemplary embodiment of a field emission device constructed as described above, if a predetermined voltage is applied between the cathode electrodes 55 and the gate electrodes 70, electrons are emitted from the fiber emitters 60, and the emitted electrons are moved toward an anode electrode 85.

An upper substrate 80 is spaced apart from the field emission device by a predetermined distance. In detail, the upper substrate 80 faces the lower substrate 50 with a predetermined distance disposed therebetween. Similar to the previous exemplary embodiments, the upper substrate 80 may include glass, or other materials having similar characteristics, e.g., the upper substrate 80 may be a glass substrate, but the present exemplary embodiment is not limited thereto. The anode electrode 85 is formed on a bottom surface of the upper substrate 80. In one exemplary embodiment, the anode electrode 85 may be formed of a transparent conductive material. A fluorescent layer 86 is formed on a bottom surface of the anode electrode 85.

In the field emission type backlight unit constructed as described above, if predetermined voltages are respectively applied to the cathode electrodes 55, the gate electrodes 70, and the anode electrode 85, electrons are emitted from the fiber emitters 60 due to the voltages applied to the cathode electrodes 55 and the gate electrodes 70. The emitted electrons are moved toward the anode electrode 85 between the gate electrodes 70, and then the emitted electrons collide with the fluorescent layer 86 to emit light.

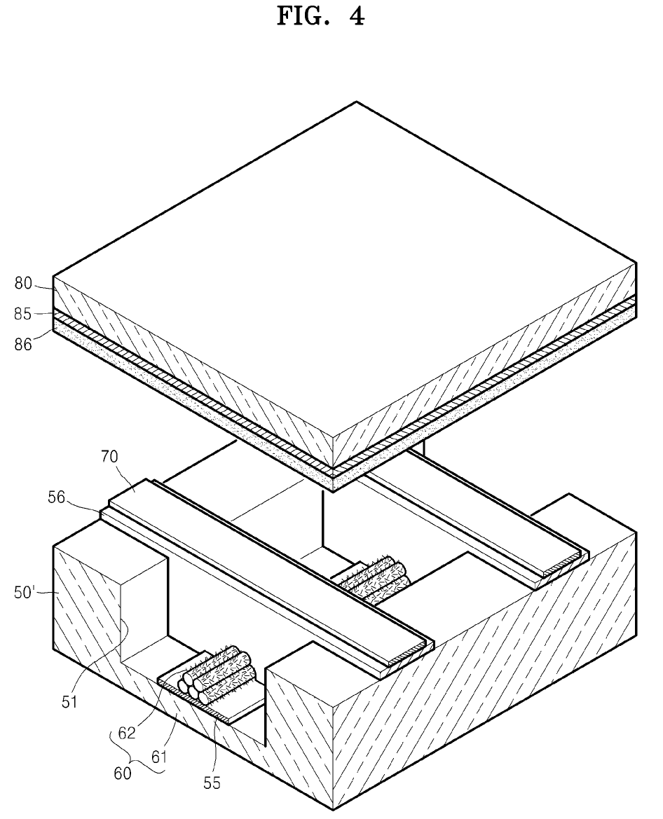

FIG. 4 is a partial perspective view of another exemplary embodiment of a field emission device and another exemplary embodiment of a field emission type backlight unit including the exemplary embodiment of a field emission device. The field emission device of FIG. 4 is substantially similar to the exemplary embodiment of a field emission device of FIG. 3 except for a difference in that the lower substrate 50 and the insulating layer 52 are integrally formed with each other. The following explanation will be made by focusing on the difference.

Referring to FIG. 4, a plurality of trenches 51 are formed to a predetermined depth in a lower substrate 50′. In one exemplary embodiment, the trenches 51 may be formed substantially in parallel with one another and may be spaced apart from one another by predetermined intervals. In one exemplary embodiment, the trenches 51 may be formed in a stripe pattern. The cathode electrodes 55 are respectively formed on bottom surfaces of the trenches 51, and the fiber emitters 60 are respectively formed on top surfaces of the cathode electrodes 55. A second insulating layer 56 is formed on the lower substrate 50′ to correspond to the gate electrodes 70, similar to the previous exemplary embodiment. In detail, the second insulating layer 56 may be formed between the gate electrodes 70 and the lower substrate 50′ to be substantially perpendicular to the cathode electrodes 55. The insulating layer 56 may partially cover the lower substrate 50′, the cathode electrodes 55, and the fiber emitters 60 which are located below the gate electrodes 70. In one exemplary embodiment, the second insulating layer 56 completely envelops the underlying portions of the fiber emitter 60 and cathode electrode 55. The gate electrodes 70 for extracting electrons from the fiber emitter 60 are formed on a top surface of the insulating layer 56 such that the gate electrodes 70 are disposed substantially perpendicular to the cathode electrodes 55. In one exemplary embodiment, the gate electrodes 70 may be formed in a stripe pattern.

Although each of the exemplary embodiments of the emission type backlight units of FIGS. 1 through 4 has a three-electrode structure including the cathode electrodes 15 or 55, the gate electrodes 30 or 70, and the anode electrode 45 or 85, the present exemplary embodiments are not limited thereto and a two-electrode structure including only the cathode electrodes 15 or 55 and the anode electrode 45 or 85 may alternatively be used.

In one exemplary embodiment, the fiber emitters 20 or 60 may be manufactured by forming the CNTs 22 or 62 on the surfaces of the conductive fibers 21 or 61, exemplary embodiments of which include metal fibers or carbon fibers as described above, using CVD, electrophoresis, electroless plating or other similar methods. In one exemplary embodiment, the CNTs 22 or 62 may be synthesized on the surfaces of the conductive fibers 21 or 61 by performing local resistive heating on the conductive fibers 21 or 61.

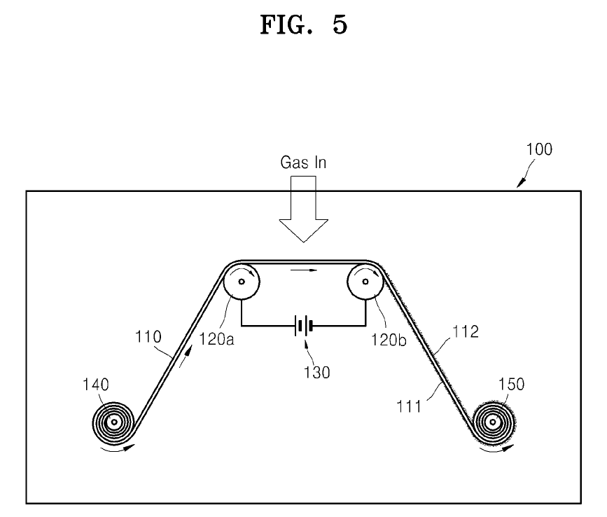

An exemplary method of synthesizing CNTs on surfaces of conductive fibers by performing local resistive heating on the conductive fibers will now be explained in more detail. FIG. 5 is a cross-sectional view of an exemplary embodiment of a device for forming CNTs on surfaces of conductive fibers using resistive heating.

Referring to FIG. 5, first and second electrode rollers 120a and 120b for moving conductive fibers 110 are installed in a chamber 100, the first and second electrode rollers 120a and 120b are spaced apart from each other by a predetermined distance. The conductive fibers 110 may be metal fibers, carbon fibers or fibers made from other materials having similar characteristics as described above. A power supply device 130 is disposed in the chamber 100 to apply a voltage difference between the first and second electrode rollers 120a and 120b. In the present exemplary embodiment, the chamber 100 is kept oxygen-free in order to prevent carbon from being combined with oxygen in the chamber 100 during a process of growing the CNTs 22 or 62. A first bobbin 140 may be further disposed in the chamber 100 to supply the conductive fibers 110 to the first electrode roller 120. The conductive fibers 110 wound around the first bobbin 140 are supplied to the first electrode roller 120 due to the rotation of the first bobbin 140.

A catalyst layer (not shown) for growing CNTs may be formed on surfaces of the conductive fibers 110 that are supplied to the first electrode roller 120a. In one exemplary embodiment, the catalyst layer may be formed by depositing a catalytic metal to a predetermined thickness on the surfaces of the conductive fibers 110. In one exemplary embodiment, the catalyst layer may be deposited using vacuum deposition, liquid-phase deposition, or other similar methods. Exemplary embodiments of the vacuum deposition may include electron beam evaporation, sputtering, and CVD, and exemplary embodiments of the liquid-phase deposition may include dip coating, spray coating, electroless plating, and electroplating. However, the present embodiment is not limited thereto.

Due to the rotations of the first and second electrode rollers 120a and 120b, the conductive fibers 110 are moved, and due to the voltage difference applied by the power supply device 130, the conductive fibers 110 moved between the first and second electrode rollers 120a and 120b are heated to a predetermined temperature. In detail, the voltage difference causes a current to flow from the first electrode roller 120a to the second electrode roller 120b (or vice versa) along the portion of the conductive fiber 110 disposed therebetween. The conductive fiber 110 presents resistance to the current flowing therealong, which causes heat in the conductive fiber 110. The temperature to which the conductive fibers 110 are heated may be adjusted according to a voltage applied between the first and second electrode rollers 120a and 120b and a distance between the first and second electrode rollers 120a and 120b. In one exemplary embodiment, the conductive fibers 110 may be heated to about 300° C. to about 1500° C. in order to grow CNTs.

CNTs 112 are grown on surfaces of the conductive fibers 110 while the conductive fibers 110 are moved between the first and second electrode rollers 120a and 120b are heated. In one exemplary embodiment, in order to promote CNT formation, a gas containing carbon is injected into the chamber 100. The gas containing the carbon may be C₂H₂, CH₄, C₂H₆, CO, or other gases having similar characteristics. However, the present exemplary embodiment is not limited thereto and any of various carbon supply sources may be used. In one exemplary embodiment, Ar, H₂, or NH₃ may be injected into the chamber 100 along with the gas containing the carbon. A second bobbin 150 for packaging conductive fibers 111, on surfaces of which the CNTs 112 are grown, may be further disposed in the chamber 100. The conductive fibers 111 on which the CNTs 112 are grown are output from the second electrode roller 120b and then wound around the second bobbin 150 to be packaged.

A method of growing the CNTs 112 on the conductive fibers 111 using resistive heating will now be explained in more detail. In the device constructed as described above, the conductive fibers 110 including the catalyst layer which is wound around the first bobbin 140 are first moved between the first electrode roller 120a and the second electrode 120b. Next, if a predetermined voltage difference is applied between the first electrode roller 120a and the second electrode roller 120b by the power supply device 130, current begins to flow through the conductive fibers 110 disposed between the first electrode roller 120a and the second electrode roller 120b, and the conductive fibers 110 are heated due to their own resistances, as described above. Accordingly, thermal energy is generated for growing the CNTs on the surfaces of the conductive fibers 110 including the catalyst layer. A temperature to which the conductive fibers 110 are heated may be adjusted according to the voltage applied between the first and second electrode rollers 120a and 120b and a distance between the first electrode roller 120a and the second electrode roller 120b.

If a gas containing carbon is applied when the conductive fibers 110 including the catalyst layer are heated, the CNTs 112 are grown on the surfaces of the conductive fibers 110. The lengths and the diameters of the CNTs 112 may be controlled according to the temperature to which the conductive fibers 110 are heated, the rotational speeds of the first and second electrode rollers 120a and 120b, and the distance between the first electrode 120a and the second electrode roller 120b. Next, when the conductive fibers 111 on which the CNTs 112 are grown pass through the second electrode roller 120b, CNT growth on the conductive fibers 111 is effectively stopped, and the conductive fibers 111 on which the CNTs 112 are grown are wound around the second bobbin 150 to be packaged. The exemplary embodiment of a method of growing the CNTs using resistive heating by heating only local regions of the conductive fibers 110 has advantages of low energy consumption, short heating and cooling times, and high throughput.

As described above, since the fiber emitters 20 and 60 including the conductive fibers and the CNTs formed on the surfaces of the conductive fibers are used as electron emission sources, electron emission characteristics and reliability can be improved without an activation process using an adhesive tape or an adhesive elastomer. Furthermore, since the CNTs are not damaged and there are no organic materials remaining in emitters, the lifespan of the fiber emitters can be extended.

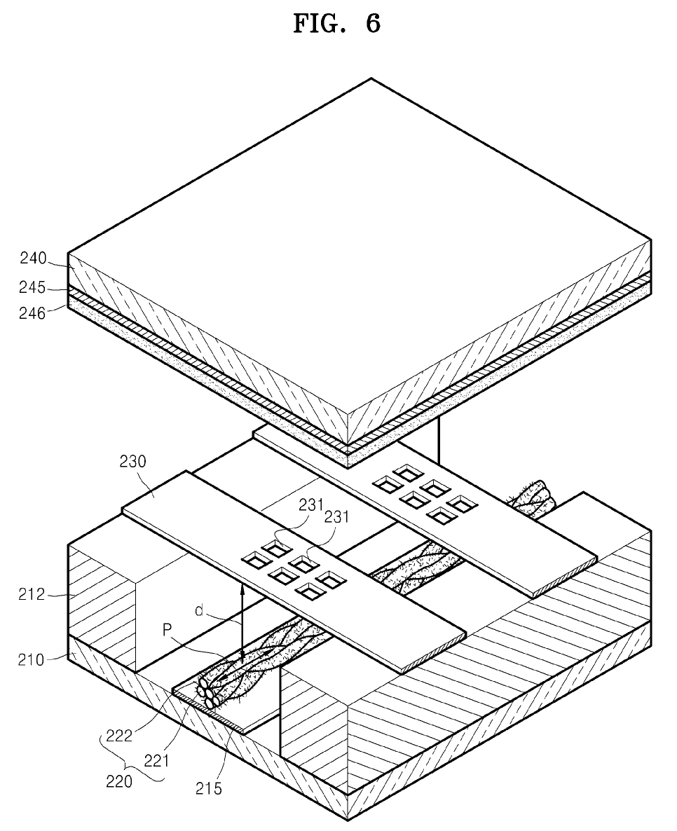

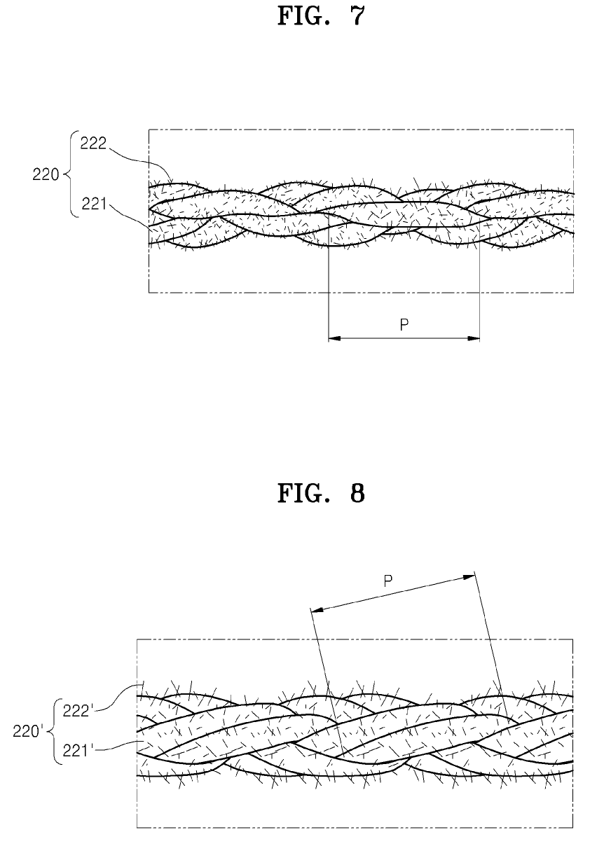

FIG. 6 is a partial perspective view of another exemplary embodiment of a field emission device and another exemplary embodiment of a field emission type backlight unit including the exemplary embodiment of a field emission device. FIG. 7 illustrates exemplary embodiments of fiber emitters 220 of the exemplary embodiment of a field emission device of FIG. 6.

Referring to FIG. 6, the exemplary embodiment of a field emission device includes a lower substrate 210, a plurality of cathode electrodes 215 formed on the lower substrate 210, a plurality of fiber emitters 220 respectively formed on top surfaces of the cathode electrodes 215, and a plurality of gate electrodes 230 for extracting electrons from the fiber emitters 220. As in the previous exemplary embodiments, the lower substrate 210 may include glass or other materials having similar characteristics, e.g., the lower substrate 210 may be a glass substrate, but there present exemplary embodiment is not limited thereto. The plurality of cathode electrodes 215 are formed on the lower substrate 210 substantially in parallel to one another at predetermined intervals. In one exemplary embodiment, the cathode electrodes 215 may be formed in a stripe pattern. Exemplary embodiments of the cathode electrodes 215 may be formed of a metal material, a transparent conductive material, exemplary embodiments of which include ITO, or other materials having similar characteristics.

The fiber emitters 220 are respectively disposed on top surfaces of the cathode electrodes 215. In one exemplary embodiment, the fiber emitters 220 may extend in the length direction of the cathode electrodes 215. Each of the fiber emitters 220 includes a plurality of conductive fibers 221 and CNTs 222 formed on surfaces of the conductive fibers 221. In the present exemplary embodiment, each of the fiber emitters 220 may be structured such that the plurality of conductive fibers 221 are braided with one another.

Some of conductive fibers 221 may be cut off, for example, in the process of forming CNTs 222 on the surfaces of the conductive fibers 221 or in the process of attaching the fiber emitters 220, or when arcing occurs around the fiber emitters 220 during the operation of the field emission device. In this case, the cut conductive fibers 221 may be short-circuited from the gate electrodes 230 if the conductive fibers are not braided. However, in the exemplary embodiment, since the conductive fibers 221 of the fiber emitters 220 are braided, even though some of the conductive fibers 221 are cut off, the cut conductive fibers 221 can be prevented from being short-circuited from the gate electrodes 230. To this end, a twist pitch P of the conductive fibers 221 may be less than a distance ‘d’ between the fiber emitters 220 and the gate electrodes 230.

In one exemplary embodiment each of the fiber emitters 220 may be configured such that three or more conductive fibers are braided together in order to prevent the braided conductive fibers 221 from being cut off and unbraided. FIG. 7 illustrates an exemplary embodiment wherein three conductive fibers are braided. However, the present exemplary embodiment is not limited thereto, and a various number of conductive fibers may be braided in various patterns. FIG. 8 illustrates another exemplary embodiment of fiber emitters 220′ of the exemplary embodiment of a field emission device of FIG. 6. In FIG. 8, reference numerals 220′, 221′, and 222′ respectively denote fiber emitters, conductive fibers, and CNTs. In the illustrations, P denotes a twist pitch between the conductive fibers 221′.

As discussed briefly above, the conductive fibers 221 may include metal fibers, carbon fibers or other materials having similar characteristics. In the exemplary embodiment wherein the conductive fibers 221 include carbon fibers, metal fibers may be further included in order to improve conductivity. The carbon fibers may have a low thermal expansion coefficient considering thermal deformation caused when electrons are emitted. In one exemplary embodiment, the carbon fibers may have a thermal expansion coefficient of about −1×10⁻⁶/K to about 5×10⁻⁶/K. However, the present exemplary embodiment is not limited thereto. The CNTs 222 having good electron emission characteristics are formed on surfaces of the conductive fibers 221 that are braided. As such, once the CNTs 222 are formed on the surfaces of the conductive fibers 221 that are braided, electric field enhancement can be achieved. The CNTs 222 may be formed on the surfaces of the conductive fibers 221 using CVD, resistive heating, or other similar methods, and the fiber emitters 220 may be manufactured by braiding the conductive fibers 221 including the CNTs 222. Alternative exemplary embodiments include configurations wherein the fiber emitters 220 may be manufactured by braiding the conductive fibers 221 and then forming the CNTs 222 on the surfaces of the conductive fibers 221 that are already braided.

Referring again to FIG. 6, an insulating layer 212 is formed to a predetermined height on a top surface of the lower substrate 210 between the cathode electrodes 215. In one exemplary embodiment, the insulating layer 212 may be formed substantially in parallel to the cathode electrodes 215. The plurality of gate electrodes 230 for extracting electrons from the fiber emitter 220 is formed on a top surface of the insulating layer 212. In one exemplary embodiment, the gate electrodes 230 may be formed in a stripe pattern substantially perpendicular to the cathode electrodes 215. One or more through-holes 231 may be formed in each of the gate electrodes 320 that are located above the fiber emitters 220. In the exemplary embodiment of a field emission device constructed as described above, if a predetermined voltage is applied between the cathode electrodes 215 and the gate electrodes 230, electrons are emitted from the fiber emitters 220, and the emitted electrons are moved toward an anode electrode 245 through the through-holes 231.

The upper substrate 240 is spaced apart from the field emission device by a predetermined distance. In detail, the upper substrate 240 faces the lower substrate 210 with a predetermined distance disposed therebetween. As discussed above, exemplary embodiments of the upper substrate 240 may include glass or other similar materials, e.g., the upper substrate is a glass substrate, similar to the lower substrate 210, but the present exemplary embodiment is not limited thereto. The anode electrode 245 is formed on a bottom surface of the upper substrate 240. Exemplary embodiments of the present invention include configurations wherein the anode electrode 245 may be formed to cover substantially the entire bottom surface of the upper substrate 240, or may be formed in a stripe pattern. In one exemplary embodiment, the anode electrode 245 may be formed of a transparent conductive material. A fluorescent layer 246 is formed on a bottom surface of the anode electrode 245.

In the exemplary embodiment of a field emission type backlight unit constructed as described above, if predetermined voltages are respectively applied to the cathode electrodes 215, the gate electrodes 230, and the anode electrode 245, electrons are emitted from the fiber emitters 220 due to the voltages applied to the cathode electrodes 215 and the gate electrodes 230. The emitted electrons are moved toward the anode electrode 245 through the through-holes 231 formed in the gate electrodes 230, and then the emitted electrons collide with the fluorescent layer 246 to emit light.

As described above, since the fiber emitters 220, each including the one or more conductive fibers 221 and the CNTs 222 formed on the surfaces of the conductive fibers 221, are used as electron emission sources, electron emission characteristics and reliability can be improved without an activation process. Furthermore, since the conductive fibers 221 are braided, a short-circuit between the cathode electrodes 215 and the gate electrodes 230 which may occur due to damage to the fiber emitters 220 can be prevented and electric field enhancement can be achieved.

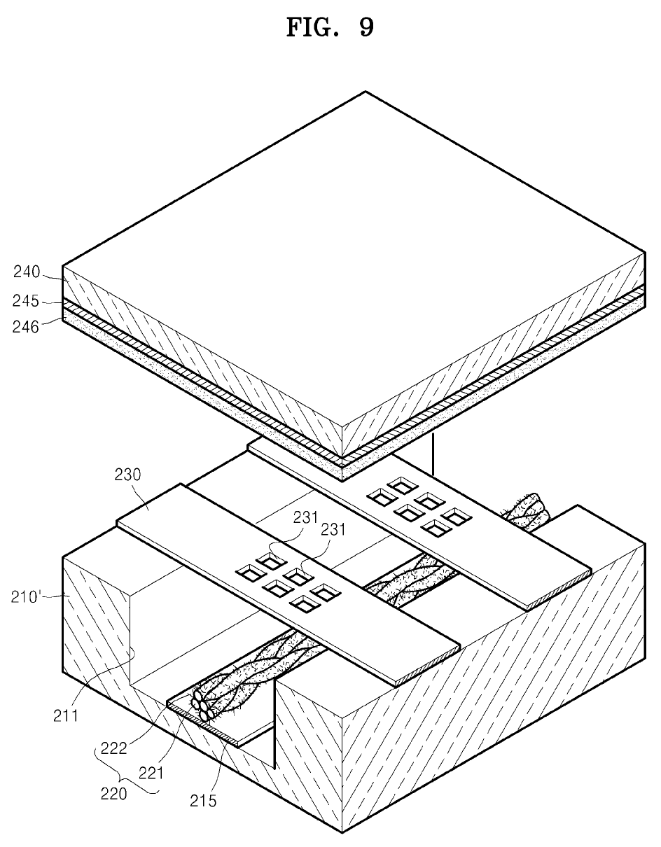

FIG. 9 is a partial perspective view of another exemplary embodiment of a field emission device and an exemplary embodiment of a field emission type backlight unit. The exemplary embodiment of a field emission device of FIG. 9 is substantially similar to the exemplary embodiment of a field emission device of FIG. 6 except for a difference in that the lower substrate 210 and the insulating layer 212 are integrally formed with each other, similar to the exemplary embodiment illustrated in FIGS. 2 and 4. The following explanation will be made by focusing on the difference.

Referring to FIG. 9, a plurality of trenches 211 are formed to a predetermined depth in a lower substrate 210′. In one exemplary embodiment, the trenches 211 may be formed substantially parallel to one another at predetermined intervals. In one exemplary embodiment, the trenches 211 may be formed in a stripe pattern. The plurality of cathode electrodes 215 are respectively formed on bottom surfaces of the trenches 211, and the plurality of fiber emitters 220 are respectively formed on top surfaces of the cathode electrodes 215. Each of the fiber emitters 220 includes conductive fibers 221, which are braided, and CNTs formed on surfaces of the conductive fibers 221. A twist pitch P between the conductive fibers 221 may be less than a distance ′d′ between the fiber emitters 220 and the gate electrodes 230. The gate electrodes 230 are formed on top surfaces of the lower substrate 10′ to be substantially perpendicular to the cathode electrodes 215. In one exemplary embodiment, the gate electrodes 215 may be formed in a stripe pattern.

Although each of the exemplary embodiments of field emission type backlight units of FIGS. 6 through 9 includes a three-electrode structure including the cathode electrodes 215, the gate electrodes 230, and the anode electrode 245, the present exemplary embodiments are not limited thereto and an exemplary embodiment of a field emission type backlight unit including a two-electrode structure including only the cathode electrodes 215 and the anode electrode 245 may be used. In such an exemplary embodiment, a twist pitch P between the conductive fibers 221 may be less than a distance between the fiber emitters 220 and the anode electrode 245.

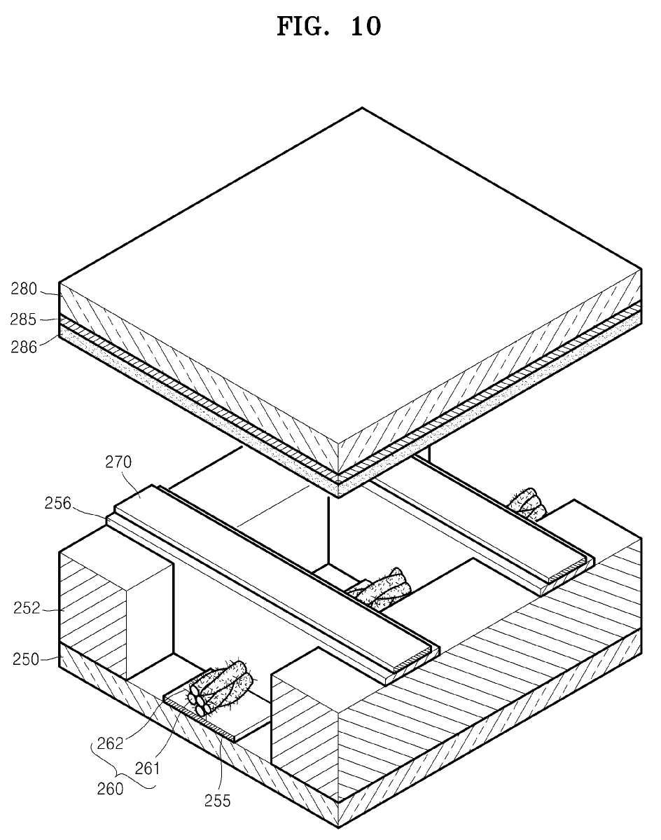

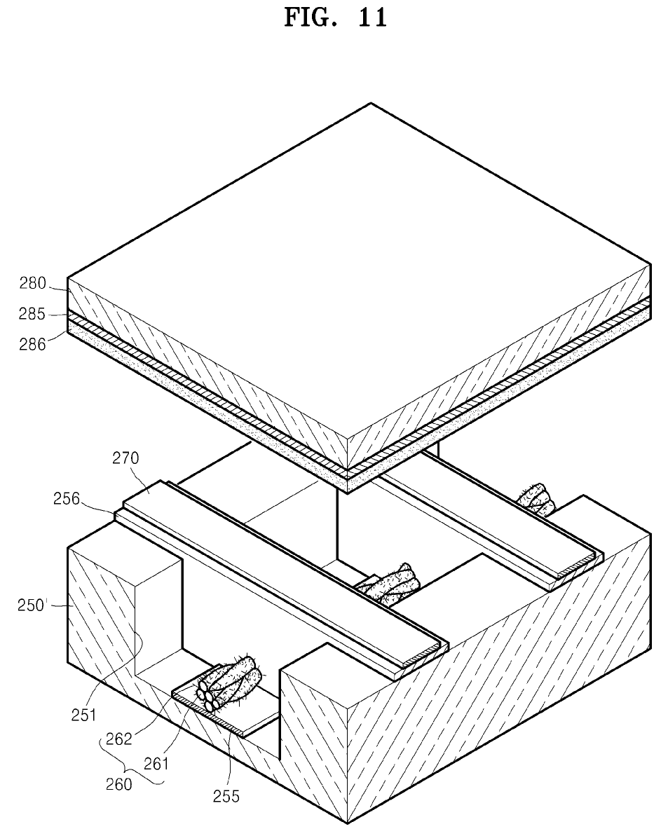

FIG. 10 is a partial perspective view of another exemplary embodiment of a field emission device and another exemplary embodiment of a field emission type backlight unit including the exemplary embodiment of a field emission device.

Referring to FIG. 10, the field emission device includes a lower substrate 250, a plurality of cathode electrodes 255 formed on the lower substrate 250, a plurality of fiber emitters 260 respectively formed on top surfaces of the cathode electrodes 255, and a plurality of gate electrodes 270 for extracting electrons from the fiber emitters 260. As discussed above, the lower substrate 250 may include glass or other materials having similar characteristics, e.g., the lower substrate 250 may be a glass substrate, but the present exemplary embodiment is not limited thereto. The plurality of cathode electrodes 255 are formed on the lower substrate 250 substantially in parallel to one another at predetermined intervals. In one exemplary embodiment, the cathode electrodes 255 may be formed in a stripe pattern. Exemplary embodiments of the cathode electrodes 255 may be formed of a metal material, a transparent conductive material, exemplary embodiments of which include ITO, or other materials having similar characteristics.

The fiber emitters 260 are respectively disposed on the top surfaces of the cathode electrodes 255. In one exemplary embodiment, the fiber emitters 260 may extend in the length direction of the cathode electrodes 255. Each of the fiber emitters 260 includes one or more conductive fibers 261, which are braided, and CNTs 262 formed on surfaces of the conductive fibers 261. In order to prevent a short-circuit between the fiber emitters 260 and the gate electrodes 270 due to cutting of some of the conductive fibers 261, a twist pitch between the conductive fibers 261 may be less than a distance between the fiber emitters 260 and the gate electrodes 270. In order to prevent the conductive fibers 261 from being cut off and unbraided, exemplary embodiments include configurations wherein each of the fiber emitters 260 may be structured such that three or more conductive fibers are braided.

Exemplary embodiments of the conductive fibers 261 may include metal fibers, carbon fibers or other materials having similar characteristics. If the conductive fibers 261 include carbon fibers, metal fibers may be included in addition in order to improve conductivity of the fiber emitter 260. The CNTs 262 having good electron emission characteristics are formed on the surfaces of the conductive fibers 261.

A first insulating layer 252 is formed to a predetermined height on a top surface of the lower substrate 250 between the cathode electrodes 255. In one exemplary embodiment, the first insulating layer 252 may be formed substantially in parallel to the cathode electrodes 255. A second insulating layer 256 is formed on the first insulating layer 252 to correspond to the gate electrodes 270. In detail, the second insulating layer 256 may be formed between the gate electrodes 270 and the first insulating layer 252 to be substantially perpendicular to the cathode electrodes 255. In one exemplary embodiment, the second insulating layer 256 may partially cover the first insulating layer 252, the lower substrate 250, the cathode electrodes 255, and the fiber emitters 260 which are located below the gate electrodes 270. In one exemplary embodiment, the second insulating layer 256 may completely envelop the underlying portions of the fiber emitter 260, cathode electrode 255 and first substrate 251. The gate electrodes 270 for extracting electrons from the fiber emitters 260 are formed on a top surface of the second insulating layer 256 such that the gate electrodes 270 are disposed substantially perpendicular to the cathode electrodes 255. In the field emission device constructed as described above, if a predetermined voltage is applied between the cathode electrodes 255 and the gate electrodes 270, electrons are emitted from the fiber emitters 260, and the emitted electrons are moved toward an anode electrode 285.

An upper substrate 280 is spaced apart from the field emission device by a predetermined distance. In detail, the upper substrate 280 faces the lower substrate 250 with a predetermined distance disposed therebetween. As described above, exemplary embodiments of the upper substrate 280 may include glass or other materials having similar characteristics, e.g., the upper substrate 280 may be a glass substrate, like the lower substrate 250, but the present exemplary embodiment is not limited thereto. The anode electrode 285 is formed on a bottom surface of the upper substrate 280. In one exemplary embodiment, the anode electrode 285 may be formed of a transparent conductive material. A fluorescent layer 286 is formed on a bottom surface of the anode electrode 285.

In the present exemplary embodiment of a field emission type backlight unit constructed as described above, if predetermined voltages are respectively applied to the cathode electrodes 255, the gate electrodes 270, and the anode electrode 285, electrons are emitted from the fiber emitters 260 due to the voltages applied to the cathode electrodes 255 and the gate electrodes 270. The emitted electrons are moved toward the anode electrode 285 between the gate electrodes 270, and then collide with the fluorescent layer 286 to emit light.

FIG. 11 is a partial perspective view of another exemplary embodiment of a field emission device and an exemplary embodiment of a field emission type backlight unit including the exemplary embodiment of a field emission device. The field emission device of FIG. 11 is substantially similar to the exemplary embodiment of a field emission device of FIG. 10 except for a difference in that the lower substrate 250 and the insulating layer 252 are integrally formed with each other. The following explanation will be made by focusing on the difference.

Referring to FIG. 11, a plurality of trenches 251 are formed to a predetermined depth in a lower substrate 250′. In one exemplary embodiment, the trenches 251 may be formed substantially in parallel to one another at predetermined intervals. In one exemplary embodiment, the trenches 51 may be formed in a stripe pattern. The cathode electrodes 255 are respectively formed on bottom surfaces of the trenches 251, and the fiber emitters 260 are respectively formed on top surfaces of the cathode electrodes 255. Each of the fiber emitters 260 includes the conductive fibers 261, which are braided, and CNTs 262 formed on surfaces of the conductive fibers 261, as described above. In one exemplary embodiment, a twist pitch between the conductive fibers 261 may be less than a distance between the fiber emitters 260 and the gate electrodes 270.

A second insulating layer 256 is formed on a portion of the lower substrate 250′ corresponding to the gate electrodes 270. In detail, the second insulating layer 256 may be formed between the gate electrodes 270 and the lower substrate 250′ to be substantially perpendicular to the cathode electrodes 255. The second insulating layer 256 may partially cover the lower substrate 250′, the cathode electrodes 255, and the fiber emitters 260 which are located below the gate electrodes 270. In one exemplary embodiment, the second insulating layer 256 may envelope the underlying portions of the field emission device. The gate electrodes 270 for extracting electrons from the fiber emitter 260 are formed on a top surface of the insulating layer 56 such that the gate electrodes 270 intersect the cathode electrodes 55. In one exemplary embodiment, the gate electrodes 70 may be formed in a stripe pattern.

Although each of the exemplary embodiments of emission type backlight units of FIGS. 10 and 11 has a three-electrode structure including the cathode electrodes 255, the gate electrodes 270, and the anode electrode 285, the present exemplary embodiments are not limited thereto and a two-electrode structure including only the cathode electrodes 255 and the anode electrode 285 may be used. In such an exemplary embodiment, a twist pitch between the conductive fibers 216 may be less than a distance between the fiber emitters 260 and the anode electrode 285.

Although the exemplary embodiment of a field emission device including the fiber emitters is applied to the field emission type backlight unit, the field emission device may be applied to other devices such as a field emission display device and an illumination device.

As described above, since fiber emitters each including a plurality of conductive fibers and CNTs formed on surfaces of the conductive fibers are used as electron emission sources, electron emission characteristics and reliability can be improved without an additional activation process. Since the CNTs are not damaged and there are no organic materials remaining in fiber emitters, the lifespan of the fiber emitters can be extended. Moreover, since exemplary embodiments of the conductive fibers are braided, a short-circuit between the cathode electrodes and the gate electrodes or between the cathode electrodes and the anode electrode, which may be caused due to damage to the fiber emitters, can be prevented, and electric field enhancement can be achieved.

While the one or more exemplary embodiments have been particularly shown and described with reference to exemplary embodiments thereof, it will be understood by one of ordinary skill in the art that various changes in form and details may be made therein without departing from the spirit and scope of the one or more embodiments as defined by the following claims.

What is claimed is:

1. A field emission device comprising:
a substrate;
a plurality of cathode electrodes disposed on the substrate; and
a plurality of fiber emitters respectively disposed on the plurality of cathode electrodes and each of the plurality of fiber emitters comprising:
at least one conductive fiber; and
a plurality of carbon nanotubes disposed on surfaces of the at least one conductive fiber.

2. The field emission device of claim 1, wherein each of the plurality of fiber emitters includes a plurality of braided conductive fibers.

3. The field emission device of claim 1, wherein the at least one conductive fiber comprises at least one of metal fibers and carbon fibers.

4. The field emission device of claim 3, wherein the carbon fibers have a thermal expansion coefficient of about −1×10⁻⁶/K to about 5×10⁻⁶/K.

5. The field emission device of claim 1, further comprising:
a first insulating layer disposed on the substrate between at least two of the plurality of cathode electrodes; and
a plurality of gate electrodes disposed on the first insulating layer, wherein the plurality of gate electrodes are disposed substantially perpendicular to the plurality of cathode electrodes.

6. The field emission device of claim 5, wherein each of the plurality of fiber emitters includes a plurality of braided conductive fibers, and a twist pitch between each of the plurality of braided conductive fibers is one of equal to and less than a distance between the plurality of fiber emitters and the plurality of gate electrodes.

7. The field emission device of claim 5, wherein each of the plurality of gate electrodes includes at least one through hole located above the plurality of fiber emitters.

8. The field emission device of claim 5, further comprising a second insulating layer disposed between the plurality of gate electrodes and the first insulating layer.

9. The field emission device of claim 8, wherein the second insulating layer at least partially covers the first insulating layer, the substrate, the plurality of cathode electrodes, and the plurality of fiber emitters located below the plurality of gate electrodes.

10. Afield emission type backlight unit comprising:
a lower substrate;
an upper substrate facing the lower substrate and being disposed a predetermined distance apart from the lower substrate;
a plurality of cathode electrodes disposed on a top surface of the lower substrate;
a plurality of fiber emitters respectively disposed on the plurality of cathode electrodes and each of the plurality of fiber emitters comprising:
at least one conductive fiber; and
a plurality of carbon nanotubes disposed on surfaces of the at least one conductive fiber;
an anode electrode disposed on a bottom surface of the upper substrate; and
a fluorescent layer disposed on the anode electrode.

11. The field emission type backlight unit of claim 10, wherein each of the plurality of fiber emitters includes a plurality of braided conductive fibers.

12. The field emission type backlight unit of claim 11, wherein a twist pitch between the plurality of braided conductive fibers is one of equal to and less than a distance between the plurality of fiber emitters and the anode electrode.

13. The field emission type backlight unit of claim 10, wherein the at least one conductive fiber comprises at least one of metal fibers and carbon fibers.

14. The field emission type backlight unit of claim 10, further comprising:
a first insulating layer disposed on a top surface of the lower substrate between at least two of the plurality of cathode electrodes; and
a plurality of gate electrodes disposed on the first insulating layer, wherein the plurality of gate electrodes are disposed substantially perpendicular to the plurality of cathode electrodes.

15. The field emission type backlight unit of claim 14, wherein each of the plurality of fiber emitters includes a plurality of braided conductive fibers, and a twist pitch between the plurality of conductive fibers is one of equal to and less than a distance between the plurality of fiber emitters and the plurality of gate electrodes.

16. The field emission type backlight unit of claim 14, wherein each of the plurality of gate electrodes includes at least one through hole aligned with the plurality of fiber emitters.

17. The field emission type backlight unit of claim 14, further comprising a second insulating layer disposed between the plurality of gate electrodes and the first insulating layer.

18. Afield emission device comprising:
a substrate including a plurality of trenches formed therein;
a plurality of cathode electrodes disposed on bottom surfaces of the plurality of trenches, respectively; and
a plurality of fiber emitters respectively disposed on the plurality of cathode electrodes and each of the plurality of fiber emitters comprising:
at least one conductive fiber; and
a plurality of carbon nanotubes disposed on surfaces of the at least one conductive fiber.

19. The field emission device of claim 18, wherein each of the plurality of fiber emitters includes a plurality of braided conductive fibers.

20. The field emission device of claim 18, wherein the at least one conductive fiber comprises at least one of metal fibers and carbon fibers.

21. The field emission device of claim 20, wherein the carbon fibers have a thermal expansion coefficient of about −1×10⁻⁶/K to about 5×10⁻⁶/K.

22. The field emission device of claim 18, further comprising a plurality of gate electrodes disposed on a top surface of the substrate and disposed substantially perpendicular to the plurality of cathode electrodes.

23. The field emission device of claim 22, wherein each of the plurality of fiber emitters includes a plurality of braided conductive fibers, and a twist pitch between each of the plurality of braided conductive fibers is one of equal to and less than a distance between the plurality of fiber emitters and the plurality of gate electrodes.

24. The field emission device of claim 22, wherein each of the plurality of gate electrodes includes at least one through hole located above the plurality of fiber emitters.

25. The field emission device of claim 22, further comprising an insulating layer disposed between the plurality of gate electrodes and the substrate.

26. The field emission device of claim 25, wherein the insulating layer at least partially covers the substrate, the plurality of cathode electrodes, and the plurality of fiber emitters located below the plurality of gate electrodes.

27. A field emission type backlight unit comprising:
a lower substrate including a plurality of trenches formed therein;
an upper substrate facing the lower substrate and being disposed a predetermined distance apart from the lower substrate;
a plurality of cathode electrodes disposed on bottom surfaces of the plurality of trenches, respectively;
a plurality of fiber emitters respectively disposed on the plurality of cathode electrodes and each of the plurality of fiber emitters comprising:
at least one conductive fiber; and
a plurality of carbon nanotubes disposed on surfaces of the at least one conductive fiber;
an anode electrode disposed on a bottom surface of the upper substrate; and
a fluorescent layer disposed on the anode electrode.

28. The field emission type backlight unit of claim 27, wherein each of the plurality of fiber emitters includes a plurality of braided conductive fibers.

29. The field emission type backlight unit of claim 28, wherein a twist pitch between the plurality of braided conductive fibers is one of equal to and less than a distance between the plurality of fiber emitters and the anode electrode.

30. The field emission type backlight unit of claim 27, wherein the at least one conductive fiber comprises at least one of metal fibers and carbon fibers.

31. The field emission type backlight unit of claim 27, further comprising a plurality of gate electrodes disposed on a top surface of the lower substrate and substantially perpendicular to the plurality of cathode electrodes.

32. The field emission type backlight unit of claim 31, wherein each of the plurality of fiber emitters includes a plurality of braided conductive fibers, and a twist pitch between the conductive fibers is less than a distance between the plurality of fiber emitters and the plurality of gate electrodes.

33. The field emission type backlight unit of claim 31, wherein each of the plurality of gate electrodes includes at least one through hole aligned with the plurality of fiber emitters.

34. The field emission type backlight unit of claim 31, further comprising an insulating layer disposed between the plurality of gate electrodes and the lower substrate.
